(19) United States
(12) Patent Application Publication
(10) Pub. No.: US 2006/0274549 A1
(43) Pub. Date: Dec. 7, 2006

(54) Multi-panel display apparatus

(75) Inventor: Hirokazu Fukuyoshi, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., Kanagawa (JP)

(21) Appl. No.: 11/446,243

(22) Filed: Jun. 5, 2006

(30) Foreign Application Priority Data
Jun. 7, 2005 (JP) 166423/2005

(51) Int. Cl. F21V 7/04

(52) U.S. Cl. 362/602; 362/604; 362/613; 362/616; 362/632; 40/546

(57) ABSTRACT

A plurality of interconnected light guide plates has a display panel disposed on a light radiating surface or each. A first movable hinge portion joint both first ends of a pair of the light guide plates for holding the light guide plates for permitting rotational movement. Second movable hinge portions join second ends of the light guide plates and stabilizing supports for permitting rotational movement between the light guide plates and the stabilizing supports. A light source unit is disposed in the first movable hinge portion to illuminating the display panels through the light guide plates.

### BACKGROUND OF THE INVENTION

1. Field of the Invention

The present invention relates to a display apparatus, and more particularly to a multi-panel display apparatus provided with a plurality of display panels mounted for rotational connection relative to one another.

2. Description of the Related Art

Recently, liquid crystal displays are widely used in electronic equipment, such as mobile phones, mobile terminals and laptop personal computers. The liquid crystal display device is mainly composed of a liquid crystal panel held a liquid crystal between an active matrix substrate including switching elements such as thin film transistors (TFTs) and a counter substrate, a backlight unit for illuminating the liquid crystal panel, and a circuit board including a signal circuit for driving the liquid crystal panel and an inverter circuit for driving the backlight unit.

The mounting structure of the liquid crystal display device can take various forms. It has been proposed to build the liquid crystal panels in the apparatus so as to display as much information as possible. For example, a foldable multi-screen type display device having a pair of display frames connected by a hinge movable between an opened state and a closed state, with a display unit and an illuminating unit respectively provided in each of the display frames, is proposed in Japanese Patent Laid-Open No. 2003-302957. However, in the device described in that document, the display unit provided in each frame is illuminated by a separate illuminating unit. This arrangement need to provide a plurality of illuminating units increase the cost.

To illuminate two display units with one illuminating unit, a structure has been proposed in which a single illuminating unit is disposed at a connection portion connecting each of the display units to each other. In that structure, a pair of liquid crystal panels are provided each with a plurality light guide plate on its each back side. Liquid crystal panel driving circuits are connected to the liquid crystal panels, respectively. Moreover, a light source consisting of Cold Cathode Fluorescent lamp (CCFL lamp) or the like, is provided in a connection portion for connecting the light guide plates. The light source is located between the light guide plates and located along a light incident surface of each of the light guide plates. A cover for preventing light leakage to the outside is disposed around this light source. Light from the light source is distributed to each of the light guide plates for illuminating each of the liquid crystal panels.

However, in that device the light guide plates are mounted rigidly with the connection portion provided with the light source. Therefore, the relative orientation of the liquid crystal panels and light guide plates is rigidly fixed in at a certain direction angle. As a result, the viewing angle of the liquid crystal panel cannot be adjusted, and double use of the display from both side with two liquid crystal panels cannot be realized. Moreover, the height of the display position of the liquid crystal panels cannot be adjusted. In this way, in the conventional multi-display device, the viewing angle or height cannot be freely adjusted and there is a problem that the display device cannot be used in various applications.

Moreover, even if the connection portion of light guide plates were made as a hinge structure, the light emitted from the light source would enter only from one end of the light guide plates, and it is would be difficult to illuminate the liquid crystal panels with high luminance and uniformity. Angular adjustment is made possible by making the liquid crystal panels capable of rotational movement, but even in this structure, the height of display positions of the liquid crystal panels cannot be adjusted, and there is a problem that the display device cannot be used in various applications.

### SUMMARY OF THE INVENTION

The invention seeks to solve or improve upon one or more of the above-described hereinafter disadvantages of the prior art. The present invention is to provide a display apparatus, more particularly a multi-panel display apparatus (referred as, “the display apparatus”) in a structure having a plurality of display panels, which can be adapted to various applications and conditions, and which can preferably illuminate the plurality of display panels with high luminance and uniformity.

The display apparatus of the present invention, comprises a plurality of the display panels on light guide plates each having a light radiating surface, first and second stabilizing supports each serving as a base portion and at least one first movable hinge portion, wherein a said first movable hinge portion is provided between and interconnects first ends of each adjacent pair of said plurality of light guide plates and permits relative rotational movement between the light guide plates of each adjacent pair. Two second movable hinge portions are provided, one of the second movable hinge portions joining a second end of the first light guide plate to said first stabilizing support and permitting relative rotational movement between the first stabilizing support and the first light guide plate, and the other second movable hinge portion joining a second end of a last light guide plate to the second stabilizing support and permitting relative rotational movement between the second stabilizing support and the last light guide plate.

In a preferred embodiment, there are two light guide plates and one first hinge. It is also preferred to provide a first light source unit in the or each first hinge.

It is preferable that the first light source unit comprises a first reflector plate having a substantially cylindrical shape provided with an opening on each of the light guide plate sides, and a first light source located in the first reflector plate, and the first reflector plate of the first light source unit functions as a rotary shaft of the first hinge portion.

It is preferable that the opening of the first reflector plate is directed toward the first and second light guide plates without reference to the rotational movement of the first movable hinge portion.

It is preferable that the display apparatus further comprising a plurality of second light source units disposed in the second movable hinge portions to illuminating the display panels through the first and second light guide plates, respectively.

It is preferable that the plurality of second light source units comprises a second reflector plate having a substantially cylindrical shape provided with an opening on each of the light guide plate sides, and a second light source located in the reflector plate, respectively, and each of the second reflector plates of the second light source units function as the rotary shafts of the second hinge portions, respectively.

It is preferable that the openings of the second reflector plates are directed toward the first and second light guide plates without reference to the rotational movement of the plurality of the second movable hinge portions, respectively.

It is preferable that one of an inverter board for driving the light source units or a circuit board for driving the display panel is provided in the stabilizing supports.

It is preferable that a view angle of the display panel is made adjustable by rotating the first and second light guide plates with the first movable hinge portion as the rotary shaft.

It is preferable that a height of the display panel is made adjustable by rotating the stabilizing supports with respect to the first and second light guide plates with the second movable hinge portions as the rotary shafts, respectively.

It is preferable that the display panel is a liquid crystal panel of either a transmissive type or semi-transmissive type.

Specifically, another display apparatus of the present invention, provided with two display panels, wherein each of the display panels is fixed to each of two light guide plates provided with hinges at both ends, respectively, wherein the hinges at one ends of the two light guide plates are fitted with each other capable of rotational movement so as to constitute a first movable hinge portion, and the hinges at the other ends of the respective light guide plates are fitted with a hinge provided at each of the two stabilizing supports serving as base portions capable of rotational movement so as to constitute a pair of second movable hinge portions. The apparatus further comprises light source units disposed at rotary shafts of the first movable hinge portion and the second movable hinge portions for illuminating the two display panels through the two light guide plates.

It is preferable that the light source units comprise a reflector plate having a substantially cylindrical shape provided with an opening on each of the light guide plate sides, and a light source located in the reflector plate, respectively, and the reflector plate of the light source unit functions as the rotary shaft of the hinge portion.

It is preferable that the opening of the reflector plate is directed toward the two light guide plates without reference to the rotational movement of the first movable hinge portion.

It is preferable that the openings of the reflector plates are directed toward the two light guide plates without reference to the rotational movement of the pair of the second movable hinge portions.

It is preferable that one of an inverter board for driving the light source units or a circuit board for driving the display panel is provided in the stabilizing supports.

It is preferable that a view angle of the display panel is made adjustable by rotating the two light guide plates with the first movable hinge portion as a rotary shaft.

It is preferable that a height of the display panel is made adjustable by rotating the stabilizing supports with respect to the light guide plate with the second movable hinge portion as a rotary shaft.

It is preferable that the display panel is a liquid crystal panel of either a transmissive type or semi-transmissive type.

According to the display apparatus of the present invention, various forms by enabling free adjustment of a view angle and a height of the display panel can be realized. The display panel can be illuminated with high luminance and uniformly and furthermore, its thin profile and light weight can be realized.

Especially, the display apparatus can be used in various forms by enabling free adjustment of a view angle and a height of the display panel. The two light guide plates are held by the first movable hinge portion provided at their one ends capable of rotational movement and two stabilizing supports are held by the second movable hinge portions provided at the other end of each of the light guide plates and each of the stabilizing supports capable of rotational movement. A view angle can be adjusted arbitrarily by rotating each of the display panels with the first movable hinge portion as the rotary shaft, and a height of the display panel can be adjusted arbitrarily by rotating the stabilizing supports with the second movable hinge portions as the rotary shaft.

Moreover, each of the display panels can be illuminated with high luminance and uniformly. Since a reflector plate is disposed in the rotary shafts of the first movable hinge portion and the second hinge portions, light can be distributed uniformly even if each of the light guide plates is rotated with the first hinge portion as the rotary shaft, and light from the light source enters each of the light guide plates from both of the first movable hinge portion and the second movable hinge portions. Furthermore, that is because the light from the light source is reflected by the reflector plate and efficiently enters the light guide plates.

Moreover, a thin and light weight display apparatus can be realized by using spaces of the hinge portions. The reflector plate provided with the light source is inserted into the first movable hinge portion and the second movable hinge portions so as to function as a rotating mechanism, its structure can be simplified and parts can be shared as compared with a structure in which the light source and the rotating mechanism are provided separately.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a perspective view of a display apparatus according to an exemplary embodiment of the present invention seen from a side;

FIG. 2 is a fragmental enlarged view for explaining a structure and light path of a first movable hinge portion of the display apparatus according to the exemplary embodiment of the present invention;

FIG. 3 is a schematic view showing an example use state of the display apparatus according to the exemplary embodiment of the present invention;

FIG. 4 is a schematic view showing other example use state, which is a height adjust state, of the display apparatus according to the exemplary embodiment of the present invention;

FIG. 5 is a schematic view showing the other example use state, which is a view angle adjusted state, of the display apparatus according to the exemplary embodiment of the present invention;

FIG. 6 is a schematic view showing an example of a use form of the display apparatus according to the exemplary embodiment of the present invention;

FIG. 7 is a schematic view showing a variation of a use form of the display apparatus according to the exemplary embodiment of the present invention; and

FIG. 8 is a schematic view showing another variation of a use form of the display apparatus according to the exemplary embodiment of the present invention.

### DETAILED DESCRIPTION OF THE PREFERRED EMBODIMENTS

First, with reference to the drawings, description will be given of a liquid crystal display apparatus according to a first exemplary embodiment of the present invention.

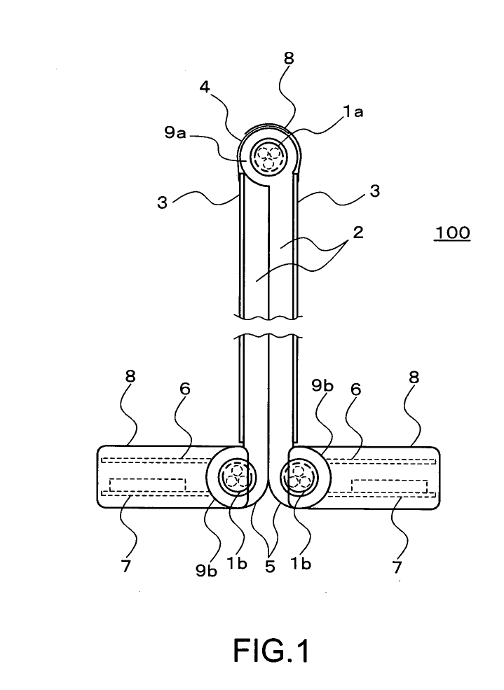

Referring to FIG. 1, a display apparatus 100 of the first exemplary embodiment of the present invention comprises a plurality of light guide plates 2, a display panels 3 disposed on a light radiating surface of each light guide plate and having first and second ends, a plurality of stabilizing supports 8 serving as base portions, respectively, a first movable hinge portion 4 joining the first end of the light guide plate 2 and the first end of the light guide plate 2 for holding the light guide plates 2 capable of rotational movement, a plurality of second movable hinge portions 5 joining the second ends of the light guide plates 2 and the stabilizing supports 8 for holding the light guide plates 2 and the stabilizing supports 8 capable of rotational movement, respectively, and a light source unit disposed in the first movable hinge portion 4 to illuminating the display panels 3 through the light guide plates 2.

In other word, the display apparatus 100 of the first exemplary embodiment of the present invention, provided with two display panels 3, wherein each of the display panels 3 is fixed to each of two light guide plates 2 provided with hinges at both ends, respectively, wherein the hinges at one ends of the two light guide plates 2 are fitted with each other capable of rotational movement so as to constitute a first movable hinge portion 4, and the hinges at the other ends of the respective light guide plates 2 are fitted with a hinge provided at each of the two stabilizing supports 8 serving as base portions capable of rotational movement so as to constitute a pair of second movable hinge portions 5. The display apparatus 100 further comprises light source units disposed at rotary shafts of the first movable hinge portion 4 and the second movable hinge portions 5 for illuminating the two display panels 3 through the two light guide plates 2.

As an example of the light source unit, holders 1a and 1b containing light sources 10 for illuminating display panels 3 through light guide plates 2 and functioning as rotary shafts of the rotating mechanisms are provided at centers of both of the first movable hinge portion 4 and the second movable hinge portions 5. As an example of the light sources 10, a cold cathode fluorescent lamp (CCFL lamp), a light emitting diode lamp (LED lamp) or the like can be used.

In the display apparatus 100, display panels 3 are provided on a front side and a rear side of a pair of light guide plates 2. In other word, display panels 3 are provided on a front side and a back side of a pair of light guide plates 2. A rotating mechanism portion for holding the pair of light guide plates 2 capable of rotational movement is provided at one ends of light guide plates 2. As an example of the rotating mechanism portion, a first movable hinge portion 4 is used. A rotating mechanism portions for holding each of light guide plates 2 and stabilizing supports 8 capable of rotational movement are provided at the other ends of light guide plates 2. The stabilizing supports 8 serve as the display base portions and contain boards 6 and 7. As an example of the rotating mechanism portion, second movable hinge portions 5 are used.

In this structure, since each of light guide plates 2 is rotationally movable to a desirable angle by first movable hinge portion 4, the view angles of display panels 3 can be optimized. That is, since luminance of light guide plates 2 is maintained even if the light guide plates 2 are moved. The display panels 3 arranged on light guide plates 2 can be seen with preferable angle, which is an optimal view angle for human eyes. Also, since stabilizing supports 8 are rotationally movable to a desirable angle by second movable hinge portions 5, the height of the display position can be optimized. That is, since stabilizing supports 8 can be rotationally moved by second movable hinge portions 5 from a horizontal state to a perpendicular state and can be fixed at a desirable angle. The height of the display apparatus 100 can be changed up to a length of the stabilizing supports 8. In a horizontal state of the stabilizing supports 8, the display apparatus 100 reaches maximum height.

Moreover, in this structure, holders 1a inserted to first movable hinge portion 4 and containing CCFL lamp or LED lamp distribute light uniformly even if light guide plates 2 are moved. Holders 1b inserted to second movable hinge portions 5 and containing CCFL lamp or LED lamp distribute light uniformly even if stabilizing supports 8 are moved. That is, since first movable hinge portion 4 and second movable hinge portions 5 are located on an extension of light guide plates 2 and integrally molded with a same resin material, for example. Therefore, the light from the CCFL lamp or LED lamp is guided similarly to the light guide plates 2. Therefore, since light emitted on the whole wall on an inner circumference of the first movable hinge portion 4 and the second movable hinge portions 5 is efficiently guided to the light guide plates 2, the light can be distributed uniformly even if light guide plates 2 are moved.

Moreover, in this structure, since the holders 1a and 1b inserted to the first movable hinge portion 4 and the second movable hinge portions 5 and containing CCFL lamp or LED lamp function as a shared light source and an exclusive light source for each of the light guide plates 2, a thin and light-weighed display can be realized even for a high-luminance device. In the present invention, by using holder 1a and 1b containing CCFL lamp or LED lamp as a shaft of movable hinge portion and by constituting holder 1a and 1b by high heat conductance material such as brass, and metal. Heat generated at the light source can be dissipated and discharged efficiently, and light emitted from the light source can be concentrated in a specific direction. Therefore, size reduction of a device and so on with a movable hinge portion is made possible.

In order to describe an exemplary embodiment of the above present invention in more detail, a display apparatus according to the embodiment of the present invention will be described referring to FIGS. 1 to 8. It is to be noted that in this embodiment, a case where a liquid crystal panel is used as a display panel will be described, but various display panel used by illuminating from back face by light guide plates may be adopted.

As shown in FIG. 1, a display apparatus in the embodiment is provided with two display panels 3 made of a transmissive or semi-transmissive liquid crystal panel, two light guide plates 2 for illuminating each of display panels 3 by guiding light from a light source, two stabilizing supports 8 holding at least one of boards 6 and 7 on which an inverter circuit for driving the light source, a signal circuit for driving display panels 3, an interface circuit, etc. is formed, first movable hinge portion 4 in a hinge structure formed at one ends of a pair of light guide plates 2, two second movable hinge portions 5 in a hinge structure formed at the other ends of respective light guide plates 2 and stabilizing supports 8, and holders 1a and 1b arranged in each of first movable hinge portion 4 and the two second movable hinge portions and containing a plurality of CCFL lamp and LED lamp.

And the pair of light guide plates 2 are held by first movable hinge portion 4 capable of rotational movement, and each of light guide plates 2 and each of stabilizing supports 8 are held by second movable hinge portions 5 capable of rotational movement. Moreover, a Tape Carrier Package (TCP), not shown, for controlling display is connected to each of display panels 3, board 6 for sending a control signal is connected to TCP and each of display panels 3 is fixed at a predetermined position on the light emitting face sides of light guide plates 2. Stabilizing supports 8 stores boards 6 and 7 and are also used as base portions for the display apparatus.

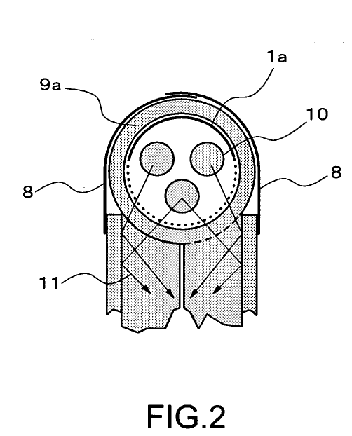

Moreover, as shown in FIG. 2, at one end of each of light guide plates 2, column portion 9a integrally molded from the same resin material, for example, is provided. The column portion 9a of each of light guide plates 2 is formed so as to be fitted with each other as a hinge. Furthermore, at other end of each of light guide plates 2, column portion 9b integrally molded from the same resin material, for example, is provided. The column portion 9b of each of light guide plates 2 is formed so as to be fitted with each other as a hinge. And holder 1a and 1b made of metal such as brass is inserted into a center portion of this column portion 9a containing one or more light sources 10 such as CCFL lamp, LED lamp, etc. This holder 1a and 1b are in a cylindrical shape to be substantially brought into contact with inner surfaces of column portions 9a and 9b, and openings are provided on the side of each of light guide plates 2 so that light 11 from light source portion 10 can enter light guide plate 2. The opening provided with the holder 1a is directed toward the light guide plates 2 without reference to the rotational movement of the first movable hinge portion 4. Moreover, the openings provided with the holders 1b are directed toward the light guide plates 2 without reference to the rotational movement of the second movable hinge portions 5. And holder 1a inserted to the shaft of first movable hinge portion 4 serves as a rotary shaft of the hinge of first movable hinge portion 4. The holder 1a rotates and holds light guide plates 2 in the state where display panels 3 are attached at a desirable angle so that the light 11 from light source 10 enters each of light guide plates 2. Also, second movable hinge portions 5 are constituted in the structure similar to that of first movable hinge portion 4. The holders 1b rotate and hold the light guide plates 2 and stabilizing supports 8 at a desirable angle so that the light from light source 10 enters each of light guide plates 2. Moreover, by stabilizing supports 8 arranged outside column portions 9a and 9b, the hinges of first movable hinge portion 4 and second movable hinge portions 5 are held so that they are not come off, and light leaking from mated faces of the hinges is reflected inside.

It is to be noted that FIGS. 1 and 2 are shown as an example, and it is only necessary that first movable hinge portion 4 holds the two light guide plates 2 capable of rotational movement, second movable hinge portions 5 hold each of light guide plates 2 and each of stabilizing supports 8 capable of rotational movement. Moreover, it is only necessary that light from light source 10 can enter each of light guide plates 2. The structure, shape, size, etc. of first movable hinge portion 4 and second movable hinge portions 5 may be modified freely. For example, it is possible that first movable hinge portion 4 or second movable hinge portions 5 and light guide plates 2 are formed as separate structural bodies and both are mated so that light can transmit for use. Or second movable hinge portions 5 may be formed smaller than first movable hinge portion 4. Moreover, the structure, shape, size, etc. of light guide plates 2, display panels 3 and stabilizing supports 8 may be selected desirable. For example, it is possible that the length of stabilizing supports 8, which is a length in the lateral direction in FIG. 1, is set equivalent to the length of display panel 3, which is a length in the longitudinal direction in FIG. 1, so that the whole surface of display panels 3 can be protected in the state where stabilizing supports 8 are folded to the side of display panels 3. Also, the arrangement, shape and size of the substrates 6 and 7 in the stabilizing supports 8 are optional. Moreover, the number, arrangement, fixed structure, etc. of CCFL lamp and LED lamp in holder 1a and 1b may be modified.

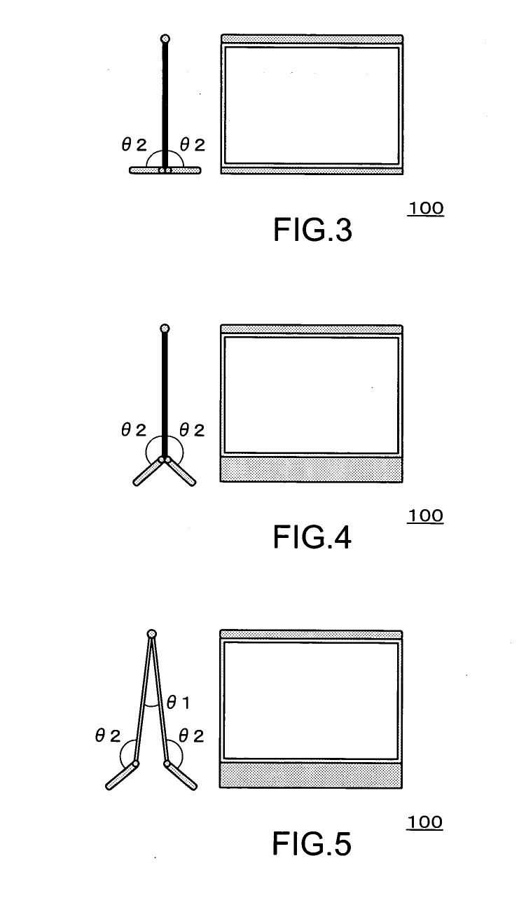

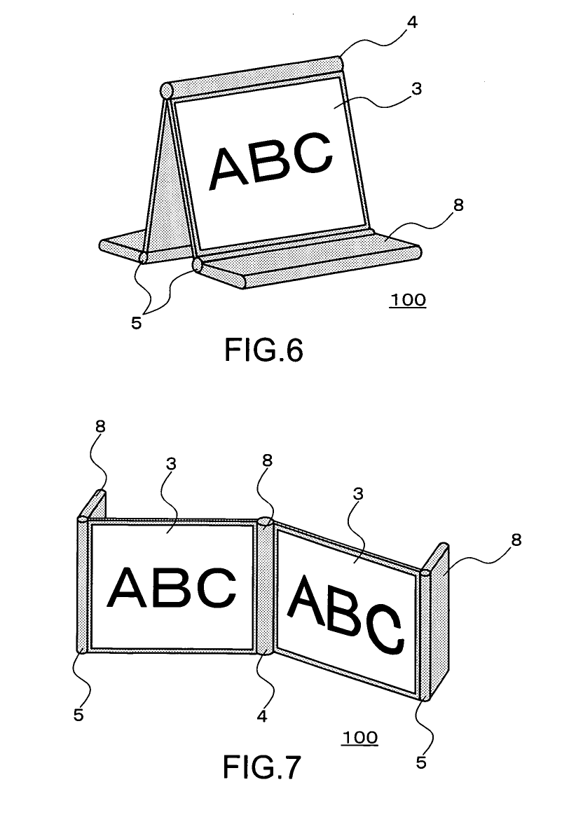

The display apparatus in the above structure can be used in various forms. When two light guide plates 2 are brought into contact with each other and an angle θ2 made by each of light guide plates 2 and each of stabilizing supports 8 is set at 90 degrees as shown in FIG. 3, face-to-face display is made possible by providing panels 3 upright in the stable state. Also, when the two light guide plates 2 are brought into contact with each other and an angle θ2 made by each of light guide plates 2 and each of stabilizing supports 8 is set greater than 90 degrees as shown in FIG. 4, the position of display panels 3 can be made higher by the length of stabilizing support 8 at the maximum by increasing the angle θ2. Also, when the two light guide plates 2 are opened by a predetermined angle θ1 as shown in FIGS. 5 and 6, display panels 3 can be adjusted to desirable visible angle.

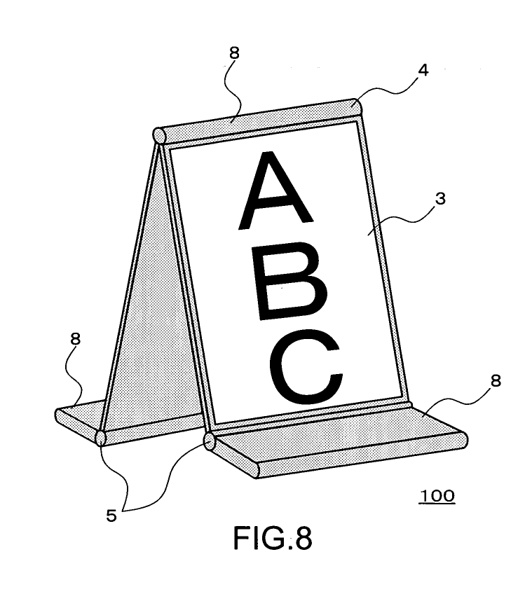

In FIGS. 3 to 6, a case is shown where first movable hinge portion 4 is arranged on an upper side, while second movable hinge portions 5 on a lower side. However, since the display apparatus of the embodiment is comprised by four structural bodies made up of two display panels 3 and two stabilizing supports 8 connected by three movable hinge portions, that can be placed stably even when laid down horizontally as shown in FIG. 7 by adjusting an angle between each of the structural bodies. Also, in FIGS. 3 to 6, horizontally long display panels 3 are used, but since two stabilizing supports 8 serve as the bases in the display apparatus of this embodiment, which can be placed stably even when vertically long display panels 3 are used as shown in FIG. 8.

In this way, in the structure provided with two display panels 3 and two light guide plates 2 integrally formed with each of display panels 3. Since first movable hinge portion 4 holding two light guide plates 2 capable of rotational movement is provided at one ends of two light guide plates 2, second movable hinge portions 5 for holding each of light guide plates 2 and stabilizing supports 8 capable of rotational movement are provided at the other ends of respective light guide plates 2. The holders 1a and 1b containing light source 10 are provided at centers of first movable hinge portion 4 and second-movable hinge portions 5 as rotary shafts. Therefore, a view angle of display panels 3 can be adjusted by adjusting an angle of two light guide plates 2 and a height of display panels 3 can be adjusted by adjusting an angle of each of light guide plates 2 and each of stabilizing supports 8. Accordingly, the display apparatus can be used in various forms. Also, by illuminating display panels 3 by providing light sources 10 at hinge portions at both ends of light guide plates 3, display panels 3 can be illuminated with high luminance and uniformly and the thin and light weight display apparatus can be realized.

The preferred embodiment has been described for the display apparatus provided with two display panels 3, but the present invention is not limited to the above embodiment but can be applied to a display apparatus provided with three or more display panels 3 as well.

The display apparatus of the present invention can be applied to various apparatus provided with a plurality of display screens connected by a movable hinge portion capable of rotational movement and can be applied to, for example, cell phone, Personal Digital Assistance (PDA), electronic dictionary, electronic book, laptop personal computer, game machine, or car navigation apparatus.

Although the exemplary embodiment of the present invention has been described above, the present invention is not limited thereto but various changes and applications maybe possible. For example, a plastic panel such as an acrylic resin panel, often used for advertising, having a feature of transparent or semi-transparent also can be used to a display panel of the present invention.

Although preferred embodiment of the invention has been described with reference to the drawings, it will be obvious to those skilled in the art that various changes or modifications may be made without departing from the true scope of the invention.

What is claimed is:

1. A display apparatus comprising:
first and second light guide plates each having a light radiating surface on which a display panel is disposed, and each having first and second ends;
first and second stabilizing supports each serving as a base portion;
a first movable hinge portion joining the first end of the first light guide plate and the first end of the second light guide plate and permitting relative rotational movement between the first and second light guide plates; and
two second movable hinge portions each joining a second end of the first and second light guide plates to a respective one of the first and second stabilizing supports and permitting relative rotational movement between the stabilizing supports and the light guide plates.

2. The display apparatus according to claim 1,
further comprising a first light source unit disposed in the first movable hinge portion to illuminate the display panels through the first and second light guide plates.

3. The display apparatus according to claim 2,
wherein the first light source unit comprises a first reflector plate having a substantially cylindrical shape provided with an opening on each of the light guide plate sides, and a first light source located in the first reflector plate, and
wherein the first reflector plate of the first light source unit functions as a rotary shaft of the first hinge portion.

4. The display apparatus according to claim 3,
wherein the opening of the first reflector plate is directed toward the first and second light guide plates without reference to the rotational movement of the first movable hinge portion.

5. The display apparatus according to claim 2,
further comprising a plurality of second light source units disposed in the second movable hinge portions to illuminating the display panels through the first and second light guide plates, respectively.

6. The display apparatus according to claim 5,
wherein the plurality of second light source units comprises a second reflector plate having a substantially cylindrical shape provided with an opening on each of the light guide plate sides, and a second light source located in the reflector plate, respectively, and
wherein each of the second reflector plates of the second light source units function as the rotary shafts of the second hinge portions, respectively.

7. The display apparatus according to claim 6,
wherein the openings of the second reflector plates are directed toward the first and second light guide plates without reference to the rotational movement of the plurality of the second movable hinge portions, respectively.

8. The display apparatus according to claim 2,
wherein one of an inverter board for driving the light source units or a circuit board for driving the display panel is provided in the stabilizing supports.

9. The display apparatus according to claim 1,
wherein a view angle of the display panel is made adjustable by rotating the first and second light guide plates with the first movable hinge portion as the rotary shaft.

10. The display apparatus according to claim 1,
wherein a height of the display panel is made adjustable by rotating the stabilizing supports with respect to the first and second light guide plates with the second movable hinge portions as the rotary shafts, respectively.

11. The display apparatus according to claim 1,
wherein, the display panel is a liquid crystal panel of either a transmissive type or semi-transmissive type.

12. A display apparatus provided with two display panels,
wherein each of the display panels is fixed to each of two light guide plates,
wherein the two light guide plates are pivotally interconnected along a first of their opposite ends by a first movable hinge portion, and
wherein the two light guide plates are each pivotally connected along a second of their opposite ends to a respective stabilizing support serving as a base portion capable of rotational movement, via a pair of second movable hinge portions,
the apparatus further comprising:
light source units disposed within the first movable hinge portion and the second movable hinge portions for illuminating the two display panels through the two light guide plates.

13. The display apparatus according to claim 12,
wherein the light source units comprise a reflector plate having a substantially cylindrical shape provided with an opening on each of the light guide plate sides, and a light source located in the reflector plate, respectively, and
wherein the reflector plate of the light source unit functions as the rotary shaft of the hinge portion.

14. The display apparatus according to claim 13,
wherein the opening of the reflector plate is directed toward the two light guide plates without reference to the rotational movement of the first movable hinge portion.

15. The display apparatus according to claim 13,
wherein the openings of the reflector plates are directed toward the two light guide plates without reference to the rotational movement of the pair of the second movable hinge portions.

16. The display apparatus according to claim 12,
wherein one of an inverter board for driving the light source units or a circuit board for driving the display panel is provided in the stabilizing supports.

17. The display apparatus according to claim 12,
wherein a view angle of the display panel is made adjustable by rotating the two light guide plates with the first movable hinge portion as a rotary shaft.

18. The display apparatus according to claim 12,
wherein a height of the display panel is made adjustable by rotating the stabilizing supports with respect to the light guide plate with the second movable hinge portion as a rotary shaft.

19. The display apparatus according to claim 12,
wherein the display panel is a liquid crystal panel of either a transmissive type or semi-transmissive type.

20. A display apparatus comprising:
a plurality of light guide plates each having a light radiating surface on which a display panel is disposed;
first and second stabilizing supports each serving as a base portion;
at least one first movable hinge portion, wherein the first movable hinge portion is provided between and interconnects first ends of each adjacent pair of the plurality, of light guide plates and permits relative rotational movement between the light guide plates of each adjacent pair; and
two second movable hinge portions, one of the second movable hinge portions joining a second end of the first light guide plate to the first stabilizing support and permitting relative rotational movement between the first stabilizing support and the first light guide plate, and the other of the second movable hinge portions joining a second end of a last light guide plate to the second stabilizing support and permitting relative rotational movement between the second stabilizing support and the last light guide plate.

21. The display apparatus according to claim 20,
further comprising a first light source unit disposed in each of said first movable hinge portions to illuminate the display panels through the adjacent pair of light guide plates.

22. The display apparatus according to claim 20,
wherein there is a total of two light guide plates and one first hinge portion.
